(19) United States
(12) Patent Application Publication
(10) Pub. No.: US 2009/0277379 A1
(43) Pub. Date: Nov. 12, 2009

(54) Film coating apparatus

(75) Inventors: Tadahiro Ohmi, Miyagi (JP); Ryoichi Ohkura, Tokyo (JP); Osamu Nakamura, Tokyo (JP); Takaaki Matsuoka, Tokyo (JP)

Correspondence Address: MASUVALLEY & PARTNERS, 8765 AERO DRIVE, SUITE 312, SAN DIEGO, CA, 92123, US

(73) Assignees: National University Corporation Tohoku University, Sendai (JP); Tokyo Electron Limited, Minato-ku (JP)

(21) Appl. No.: 12/311,396

(22) PCT Filed: Sep. 28, 2007
(86) PCT No.: PCT/JP2007/068936

§ 371 Date: Mar. 27, 2009

(30) Foreign Application Priority Data
Sep. 29, 2006 (JP) 2006-266259

(51) Int. Cl. B05B 13/02

(52) U.S. Cl. 118/302; 118/730

(57) ABSTRACT

A gas ejected from a sonic nozzle toward the rear surface of a wafer. The flow speed of the gas flowing to the outer circumference side along the rear surface of the wafer is increased between the rear surface of the wafer and a second cup and is kept by Bernoulli's effects. Thus, flapping of wafer is suppressed. Furthermore, a resist solution is prevented from flowing around to the rear surface.

This application claims priority under 35 U.S.C. § 371 as a National Stage application of PCT application Serial No. PCT/JP2007/068936, filed Sep. 28, 2007, entitled “FILM COATING APPARATUS”, which is incorporated herein by reference in its entirety.

### TECHNICAL FIELD

The present invention relates to a film coating apparatus for applying an organic coating and the like to an accurate substrate including a semiconductor substrate, a liquid crystal glass substrate, or a magnetic disc and the like.

### BACKGROUND OF THE INVENTION

In the manufacture of a semiconductor device, a liquid crystal display, a magnetic disc and the like, an exposure technology is used to form a circuit pattern. Applying a resist material, which is required in an exposure step, to an accurate substrate uniformly and thinly as much as possible is necessary and important factor in order to achieve the miniaturization of an accurate substrate element, and the high quality and the high yield ratio of device manufactures of a semiconductor and others. Accordingly, coating apparatuses have been conventionally improved so as to apply resist materials to an accurate substrate uniformly and thinly as much as possible in the exposure step.

Further, in accordance with the high integration and the high accuracy of each device including a semiconductor and the others, contaminating factors regarded as problems become increasingly serious. Not only heavy-metal contaminations but also environmental particle contaminations and the contaminations from manufacturing devices are regarded as problems, and there are needs to remedy those problems.

Furthermore, in an etching step after the exposure step, impurities such as moisture and oxygen contained in the resist damage the resist material. Therefore, in order to apply the resist material described above to an accurate substrate uniformly and thinly as much as possible, it is required to prevent the contamination in the level of atoms and molecules such as moisture and oxygen when the resist is applied.

As shown in FIG. 5, a conventional film coating apparatus has a table 52 for retaining a substrate to be coated 51, a rotation mechanism 53 for rotationally driving the table 52, a resist nozzle 54 for supplying a resist liquid to a surface to be coated of the substrate to be coated 51, a first cylindrical cup 55 configured to enclose the substrate to be coated 51, a second cup 56 configured to position within the first cup 55 and in the lower side of the substrate to be coated 51, a EBR device 57, a wash nozzle 58 and a casing (not shown) for housing those.

In order to apply the resist liquid to the substrate to be coated 51 using the apparatus in FIG. 5, firstly, the substrate to be coated 51 is retained by the table 52. The table 52, for example, a vacuum chuck, vacuum-holds and retains the substrate to be coated 51. The exhausts from the vacuum chuck are conducted through the rotation mechanism 53 as shown by the down-pointing arrow.

Next, the resist liquid is supplied to the surface center of the substrate to be coated 51 by the resist nozzle 54 as shown by the down-pointing arrow, and the table 52 is rotated by the rotation mechanism. As a result, the substrate to be coated 51 is rotated, and the resist liquid supplied to the surface of the substrate spreads toward the edge (in a direction toward the outer circumference) of the substrate to be coated 51 by centrifugal force. Therefore, the resist liquid supplied to the surface of the substrate becomes a resist film which covers the entire surface of the substrate to be coated 51.

The resist film formed as described above tends to have a thicker at the periphery of the edge. In a case when the film at the periphery of the edge is thick, an edge wash liquid and the like are supplied by the Edge Bead Removal device 57 as shown by the down-pointing arrow so as to remove a part of the resist film and thereby achieving a predetermined thickness. In addition, the resist which intrudes into the rear surface of the substrate to be coated 51 is removed by squirting a solvent from the wash nozzle 58 in the direction shown by the obliquely upward pointing arrow.

As described above, the resist film is formed on the surface of the substrate to be coated 51 using the conventional film coating apparatus.

### DISCLOSURE OF THE PRESENT INVENTION

### Problems To Be Solved By The Present Invention

In the conventional film coating apparatus, the film thickness distribution of the formed resist film is nonuniform (especially, the film at the edge tends to be thicker). Therefore, the conventional film coating apparatus has a problem that a treatment to uniform the film thickness, using the EBR process and the like, has to be necessary.

Further, in the conventional film coating apparatus, the resist liquid intrudes into the rear surface of the substrate to be coated. Therefore, the conventional film coating apparatus has a problem that the rear surface of the substrate to be coated has to be rinsed.

Furthermore, in the conventional film coating apparatus, a wafer flaps at its outer circumference portion when the wafer is rotated at high speed. Therefore, there is a problem that the conventional apparatus cannot cope with the increasing size of diameters of the wafer.

Furthermore, in the conventional film coating apparatus, there is a problem that a pulsation occurs on the resist when the resist is applied.

Furthermore, in the conventional film coating apparatus, there is a problem that the formed resist film is etched by an etching process after an exposure step. This problem can be resolved to a certain degree by coating the film thicker. However, making the film thickness thicker has harmful effects on the focus depth at the exposure step, and causes another problem that makes it difficult to achieve the miniaturization.

Accordingly, an object of the present invention is to provide a film coating apparatus which can achieve both of the simplification of steps and the equalization of the film thickness distribution of a resist film, and which can cope with the increasing size of diameters of wafers.

### MEANS TO SOLVE THE PROBLEMS

In a film coating apparatus according to a first configuration of the present invention, the apparatus includes one or more means selected from the group of a means for supplying a gas uniformly from a portion facing a surface not to be coated of a substrate to be coated, a means for supplying a gas to a rotation retaining mechanism which is capable of retaining the substrate to be coated horizontally and rotate the substrate to be coated, and a gas supply means for controlling an atmosphere in a coating liquid dispensing mechanism for dispensing the coating liquid toward a surface to be coated of the substrate to be coated.

In a film coating apparatus according to a second configuration of the present invention, the apparatus includes a rotation retaining mechanism for horizontally retaining a substrate to be coated and rotating the substrate to be coated, wherein the rotation retaining mechanism has a table for directly or indirectly retaining the substrate to be coated and a gas supply means including a gas discharge hole for supplying a gas to a rear surface of the substrate to be coated.

In a film coating apparatus according to a third configuration of the present invention, regarding the film coating apparatus of the second configuration, the table has a chuck which directly contacts with and retains a portion of the rear surface of the substrate to be coated.

In a film coating apparatus according to a fourth configuration of the present invention, regarding the film coating apparatus of the third configuration, the chuck is a vacuum chuck or an electrostatic chuck.

In a film coating apparatus according to a fifth configuration of the present invention, regarding the apparatus according to the second configuration, the table has a Bernoulli chuck which retains at least a portion of the rear surface of the substrate to be coated without contacting with the rear surface of the substrate to be coated.

In a film coating apparatus according to a sixth configuration of the present invention, the apparatus includes a rotation retaining mechanism for horizontally retaining a substrate to be coated and rotating the substrate to be coated, wherein the rotation retaining mechanism has a table for indirectly retaining the substrate to be coated and has a gas discharge hole for supplying a gas into a space between the substrate to be coated and the table, wherein the gas supplied from the gas discharge hole is exhausted from an outer circumference of the substrate to be coated at a flow speed greater than that of the gas which flows at other portions except for the outer circumference.

In a film coating apparatus according to a seventh configuration of the present invention, regarding the film coating apparatus of any one of the second to the sixth configurations, a diameter at an ejection passage of the gas discharge hole is smaller than that at an upstream passage, to which the gas is supplied, of the gas discharge hole.

In a film coating apparatus according to an eighth configuration of the present invention, regarding the film coating apparatus of the fifth or the sixth configuration, the table includes a plurality of clamp pins for clamping an outer circumference portion of the substrate to be coated.

In a film coating apparatus according to a ninth configuration of the present invention, regarding the film coating apparatus of the fifth or the sixth configuration, an upper surface of the clamp pin is positioned at the same height as the surface to be coated of the substrate to be coated, or the upper surface of the clamp pin is positioned at a higher place than the surface to be coated of the substrate to be coated when the table retains and rotates the substrate to be coated.

### EFFECTS OF THE INVENTION

According to the present invention, using a gas flow can prevent the resist liquid from intruding into the rear surface, and the uniform film thickness distribution can also be achieved by the gas flow. Accordingly, the present invention can omit the step for rinsing the rear surface and the step for making the film thickness evenly using the EBR.

In addition, according to the present invention, a wafer flapping along with the high speed rotation can be suppressed, and it is possible to cope with the increasing size of diameters of wafers.

Further, according to the present invention, a pulsation of the resist liquid can be suppressed.

Furthermore, according to the present invention, the intrusion of the impurities into the resist film can be suppressed, and therefore, it can be suppressed to etch the resist by the etching process after the exposure step. Therefore, it is possible to achieve a thinner film, and it is possible to realize the miniaturization and the continuous processes.

### BRIEF DESCRIPTION OF THE DRAWINGS

FIG. 1 is a schematic block diagram of a major portion of a film coating apparatus according to a first embodiment of the present invention.

FIG. 2 is a schematic block diagram of a major portion of a film coating apparatus according to a second embodiment of the present invention.

FIG. 3A is a view for explaining states of load/unload of the film coating apparatus illustrated in FIG. 2.

FIG. 3B is a view for explaining a state when a resist is applied by the film coating apparatus illustrated in FIG. 2.

FIG. 4 is a schematic block diagram of a film coating apparatus according to a third embodiment of the present invention.

FIG. 5 is a schematic block diagram of a major portion of a conventional film coating apparatus.

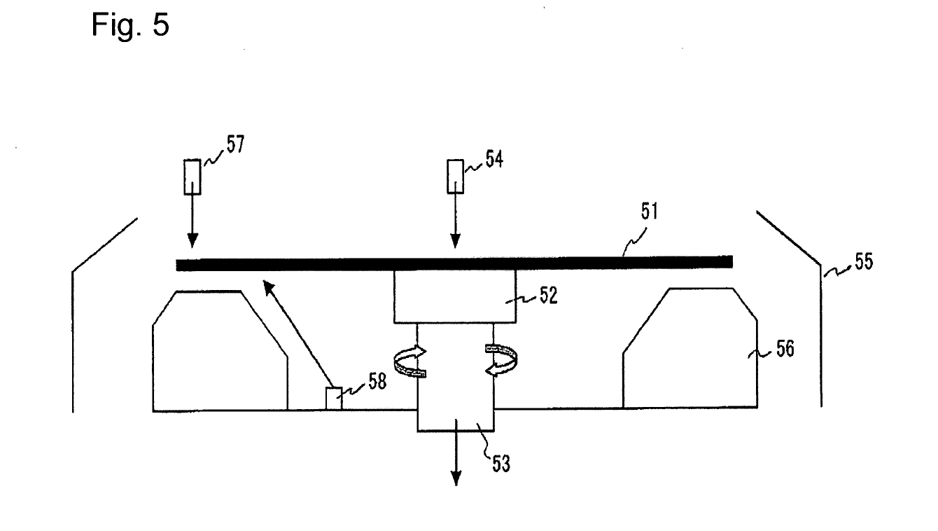

### EXPLANATIONS OF NUMERALS

10 FILM COATING APPARATUS
11 SUBSTRATE TO BE COATED
12 TABLE
13 ROTATION MECHANISM
14 RESIST NOZZLE
15 FIRST CUP
16 SECOND CUP
17 SONIC NOZZLE
20 FILM COATING APPARATUS
21 SUBSTRATE TO BE COATED
22 TABLE
221 MAIN TABLE
222 SONIC NOZZLE
223 RING-SHAPED PROJECTION
224 CLAMP PIN
23 ROTATION MECHANISM
24 RESIST NOZZLE
25 CUP
31, 32 BERNOULLI CHUCK
40 FILM COATING APPARATUS
41 SUBSTRATE TO BE COATED
42 CASING
43 PUMP
44 DEAERATING FILM
45 RESIST SUPPLY PIPING
46 GAS SUPPLY SECTION
47 GAS EXHAUST SECTION
51 SUBSTRATE TO BE COATED
52 TABLE
53 ROTATION MECHANISM
54 RESIST NOZZLE
55 FIRST CUP
56 SECOND CUP
57 EBR DEVICE
58 WASHING NOZZLE FOR REAR SURFACE

### BEST MODE FOR CARRYING OUT THE INVENTION

The best mode for carrying out the present invention will be explained below with reference to the drawings.

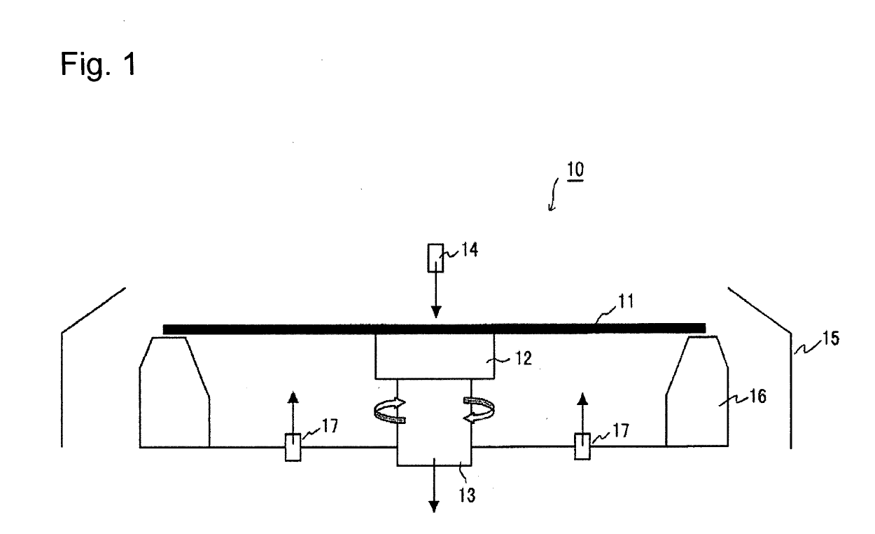

FIG. 1 illustrates a schematic block diagram of a film coating apparatus according to one embodiment of the present invention.

A film coating apparatus 10 illustrated in FIG. 1 includes a table 12 for retaining a substrate to be coated 11, a rotation mechanism 13 for rotationally driving the table 12, a resist nozzle 14 for supplying a resist liquid to a surface of the substrate to be coated 11, a first cylindrical cup 15 configured to enclose the substrate to be coated 11, a second cup 16 positioned within the first cup 15 and in the lower side of the substrate 11, a gas supplying nozzle, for example, a sonic nozzle 17, for ejecting the gas toward a rear surface of the substrate to be coated 11 and a casing (not shown) for housing those.

The substrate to be coated 11 is, for example, an accurate substrate such as a semiconductor substrate, a liquid crystal glass substrate, or a magnetic disc.

The table 12, which is a vacuum chuck or an electrostatic chuck, contacts with and retains directly the substrate to be coated 11. In a case the table is the vacuum chuck, the exhaust is conducted through the rotation mechanism 13 as shown by the down-pointing arrow.

The rotation mechanism 13 configures a rotation retaining mechanism together with the table 12. The rotation mechanism 13 moves the table 12 upwardly and downwardly so as to load/unload the substrate to be coated 11. In addition, the rotation mechanism 13 rotationally drives the table 12 so as to rotate the substrate to be coated 11, which is retained by the table 12, using its central axis as an axis of rotation.

The resist nozzle 14 supplies a resist liquid to the surface center (the surface to be coated) of the substrate to be coated as shown by the down-pointing arrow.

The first cup 15 collects the resist liquid which is supplied to the surface of the substrate to be coated 11 and is peripherally spattered along with the rotation of the substrate to be coated 11.

The second cup 16 defines the flow passage of a gas (inert gases including N₂ and the like) supplied from the lower side of the substrate to be coated, and promotes the collection of the resist liquid by the first cup 15.

The sonic nozzle 17 has a gas discharge hole whose diameter at its ejection passage is smaller than that at its upstream passage to which the gas is supplied. The sonic nozzle 17 ejects the gas of a certain amount of flow with a high degree of accuracy toward the rear surface (the surface not to be coated) of the substrate to be coated 11 as shown by the up-pointing arrow. Arranging a plurality of sonic nozzles 17 in a regular way can result in supplying the gas uniformly toward the rear surface of the substrate to be coated 11.

Then, the operation of the film coating apparatus illustrated in FIG. 1 will be explained.

First of all, the table 12 is moved upwardly by the rotation mechanism 13, and the substrate to be coated 11 is retained by the table 12.

Then, the table 12 is moved downwardly to a treatment position by the rotation mechanism 13, and the resist liquid is supplied to the surface center of the substrate to be coated 11, retained by the table 12 by the resist nozzle 14.

Subsequently, the gas is ejected from the sonic nozzle 17 while the table 12 is rotated by the rotation mechanism 13. The resist liquid supplied to the surface of the substrate to be coated 11 spreads to the edge portion of the substrate to be coated 11 due to the rotation of the table 12. At this time, after the ejected gas from the sonic nozzle 17 reaches the rear surface of the substrate to be coated 11, the gas flows toward the edge (the outer circumference side) along the rear surface of the substrate to be coated 11. The upper edge portion of the second cup 16 is adjacent to the edge portion of the rear surface of the substrate to be coated 11 so that the flow passage is narrow. At this portion, the flow speed of the gas is increased, and therefore, the edge portion of the substrate to be coated 11 is held (indirectly) by Bernoulli's effects. That is, there is a Bernoulli chuck at the edge portion. As a result, the flapping of the substrate to be coated 11 can be suppressed, and therefore, the substrate to be coated 11 can be rotated at high speed. Further, the synergic effect of the high-speed rotation and the gas stream can improve the film thickness distribution of the resist, and can eliminate the intrusion of resist into the rear surface. Accordingly, the EBR step and the rinsing step for the rear surface, which are conventionally necessary, can become unnecessary, and the EBR apparatus and the nozzle for rinsing the rear surface can become unnecessary. In this embodiment, since the rotation is provided at the chuck placed at the center portion where the inertia moment is low, it is possible to rotate from a low speed to a high speed such as 6,000 to 7,000 rpm in a short time (for example, one second), and the flapping at the outer circumference portion along with the high-speed rotation can be suppressed by the Bernoulli chuck.

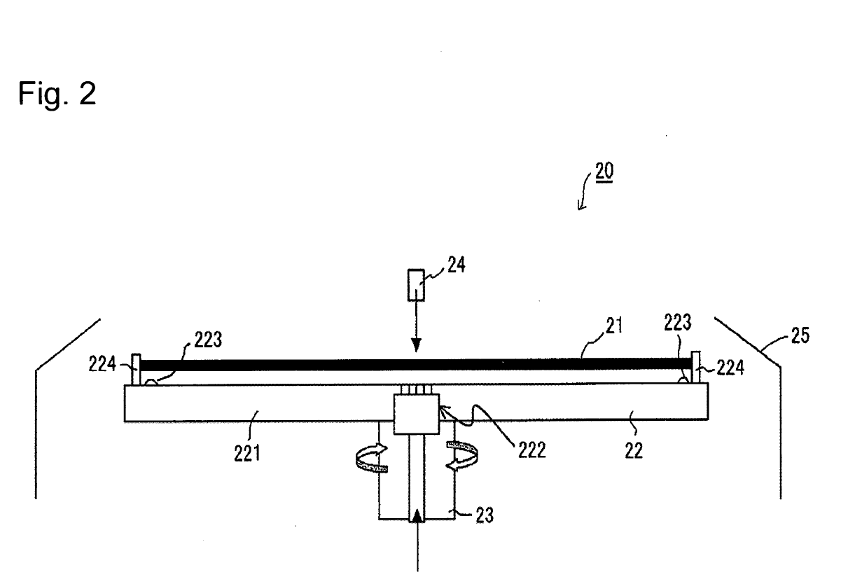

Next, a second embodiment of the present invention will be explained with reference to FIG. 2.

A film coating apparatus 20 illustrated in FIG. 2 includes a table 22 for retaining a substrate to be coated 21, a rotation mechanism 23 for rotationally driving the table 22, a resist nozzle 24 for supplying a resist liquid to a surface of the substrate to be coated 21, a cylindrical cup 25 configured to enclose the substrate to be coated 21 and a casing (not shown) for housing those.

The table 22 has a disk-shaped main table 221, a gas supplying nozzle positioned on the center of the table, for example, a sonic nozzle 222, a ring-shaped projection 223 positioned on the upper periphery of the main table 221 and a plurality of clamp pins 224 positioned on the outer circumference side of the ring-shaped projection 223. The table 22, as describe below, retains the substrate to be coated 21 without contacting with the rear surface of the substrate to be coated 21. The gas is supplied to the sonic nozzle 222 through the rotation mechanism 23 as shown by the up-pointing arrow.

The rotation mechanism 23 configures the rotation retaining mechanism together with the table 22. The rotation mechanism 23 moves the sonic nozzle 222 upwardly and downwardly so as to load/unload the substrate to be coated 21. In addition, the rotation mechanism 23 rotationally drives the table 22 so as to rotate the substrate to be coated 21, which is retained by the pin 224, using its central axis as an axis of rotation.

The resist nozzle 24 supplies a resist liquid to the surface center of the substrate to be coated 21 as shown by the down-pointing arrow.

The cup 25 collects the resist liquid which is supplied to the surface of the substrate to be coated 21, and spatters peripherally along with the rotation of the substrate to be coated 21.

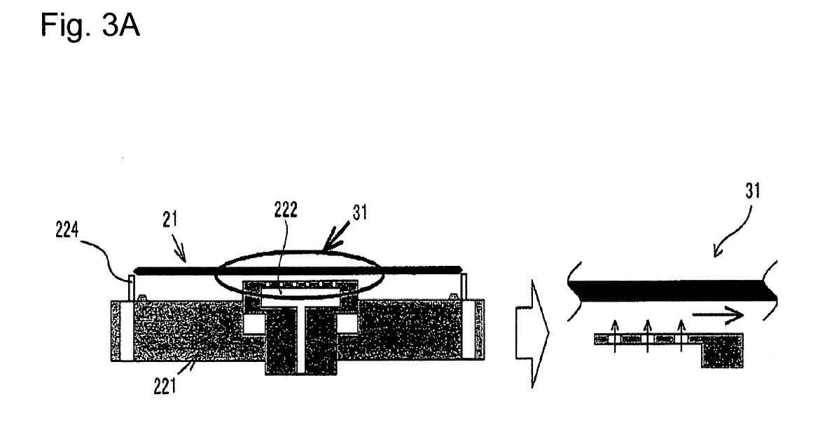

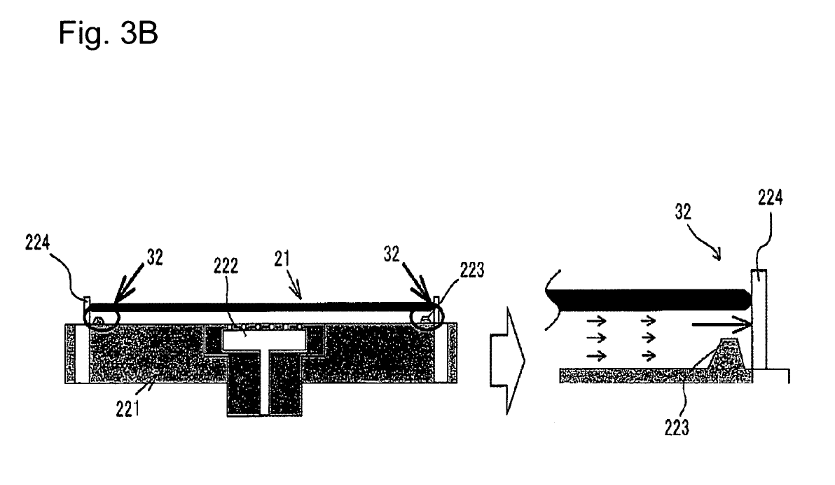

Then, the operation of the film coating apparatus illustrated in FIG. 2 will be explained with reference to FIGS. 3A and 3B. On the right side of each of FIGS. 3A and 3B, (partial) enlarged illustration of Bernoulli chuck portion 31 or 32 is illustrated.

First of all, the sonic nozzle 222 is moved upwardly by the rotation mechanism 23 as shown in FIG. 3A, and the substrate to be coated 21 is positioned on the upper side of the sonic nozzle 222. The sonic nozzle 222 has a plurality of gas discharge holes whose diameter at its ejection passage is smaller than that at its upstream passage. The gas discharge holes are formed to be regularly arranged. The sonic nozzle 222 ejects a gas (N₂) of a certain amount of flow upwardly as shown by the up-pointing arrow in the enlarged illustration. The ejected gas from the sonic nozzle 222 reaches the rear surface of the substrate to be coated 21, and flows toward the edge of the substrate to be coated 21 along the rear surface of the substrate to be coated 21 as shown by the right-pointing arrow in the enlarged illustration. Here, if the flow rate of the gas ejected from the gas discharge hole is set appropriately based on the weight of the substrate to be coated 21, the gases ejected from a plurality of the gas discharge holes are gathered at the periphery of the sonic nozzle 222, and therefore, the gas flow speed is increased (for example, the flow speed is about 5 m/sec). Therefore, the substrate to be coated 21 can be fixed in certain location (vacuum holding and retain) by Bernoulli's effects without contacts. Namely, the sonic nozzle 222 works as a Bernoulli chuck 31.

Then, the sonic nozzle 222 is moved downwardly by the rotation mechanism 23, and the upper surface of the sonic nozzle 222 is brought into a line of the upper surface of the main table 221 as shown in FIG. 3B. At this time, the clamp pin 224 contacts with the outer circumferential surface of the substrate to be coated 21, and guides the substrate to be coated 21.

In a state illustrated in FIG. 3B, the gas ejected from the sonic nozzle 222 flows toward the outer circumference of the substrate to be coated 21, as shown by the right-pointing arrow in the enlarged illustration, in the space between the substrate to be coated 21 and the main table 221. The gas passage formed by the substrate to be coated 21 and the main table 221 is narrowed by the ring-shaped projection 223 formed on the upper surface of the main table 221, and the gas flow speed at the point is increased (for example, the flow speed is 7 m/sec). As a result, the gas is exhausted from the outer circumference of the substrate to be coated 21 at a higher speed of flow than the speeds of flow at other portions. Then, the substrate to be coated 21 can be fixed securely in an absolute location (vacuum holding and retain) against the main table 221 by Bernoulli effects without making at least the rear surface of the substrate to be coated 21 contact with the table. Namely, the outer circumference portion of the table 221 works as a Bernoulli chuck 32 due to the presence of the ring-shaped projection 223. Accordingly, in the film coating apparatus according to the present embodiment, like the apparatus according to the first embodiment, the flapping of the substrate to be coated 21 can be suppressed, and it is possible to rotate the substrate to be coated 21 at high speed.

Then, the resist liquid is supplied to the surface center of the substrate to be coated 21 by the resist nozzle 24, and the table 221 is rotated by the rotation mechanism 23 so as to rotate the substrate to be coated 21. Accordingly, the resist liquid supplied to the surface of the substrate spreads toward the edge portion of the substrate to be coated 21, and the resist film is formed.

As described above, since the film coating apparatus according to this embodiment can also prevent the substrate to be coated 21 from flapping, the synergic effect of the high-speed rotation and the gas stream can improve the film thickness distribution of the resist, and can eliminate the intrusion of resist into the rear surface. Accordingly, the EBR step and the washing step for the rear surface, which are conventionally necessary, can become unnecessary, and the EBR gun and the nozzle for washing the rear surface can also become unnecessary.

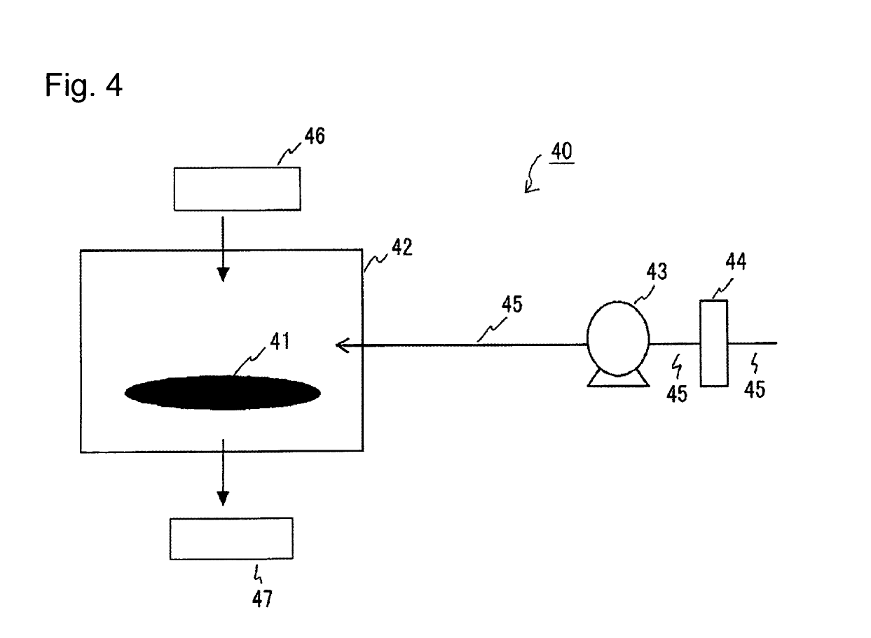

Next, a film coating apparatus according to a third embodiment of the present invention will be explained with reference to FIG. 4.

A film coating apparatus 40 illustrated in FIG. 4 includes a table (not shown) for retaining a substrate to be coated 41, a casing 42 for housing a resist nozzle for supplying a resist liquid and the like, a pump 43 for supplying the resist liquid to the resist nozzle, a deaerating film 44 for removing oxygen and the like included in the resist liquid, a resist supply piping 45 for connecting those, a gas supply section 46 for introducing a gas into the casing 42 and a gas exhaust section 47 for exhausting the gas in the casing 42.

In the present embodiment, a material having a low gas permeability coefficient is used for the resist supply piping 45, and the deaerating film 44 is placed at the upper position of the pump 43 to remove oxygen and moisture contained in the resist liquid.

In addition, in the present embodiment, the exhaust is conducted while a gas from which oxygen and moisture are removed, for example, N₂ is introduced into the casing 42, which results in controlling the atmosphere in the casing 42. In other words, the atmosphere during the formation of the resist film on the surface of the substrate to be coated 41 is controlled in a state where the content of oxygen and moisture is extremely low. That is, the gas supplying section 46, for introducing the gas into the casing 42 has a function to control the atmosphere during the injection of the coating liquid. As a result, commingling of impure substances (oxygen, moisture) with the resist film can be suppressed during the formation of the resist film on the surface of the substrate to be coated 41, and etching of the resist film by the impure substances can be suppressed during an RIE which is conducted after the exposure step. Accordingly, it is possible to make a thinner resist film, and it is possible to realize the miniaturization and the continuous processes. In addition, the pulsation can be suppressed during the resist coating.

As described above, the present invention has been explained along with several embodiments. However, the present invention does not limited to those of the embodiments.

For example, although the case, in which the coating film is the resist film, is explained in the embodiments described above, the coating film may be a polyimide film or a interlayer insulating film formed from SOG or SOD material.

1. A film coating apparatus comprising:
one or more means selected from the group of a means for supplying a gas uniformly from a portion facing a surface not to be coated of a substrate to be coated, a means for supplying a gas to a rotation retaining mechanism which is capable of retaining the substrate to be coaled horizontally and rotate the substrate to be coated, and a gas supply means for controlling an atmosphere in a coating liquid dispensing mechanism for dispensing the coating liquid toward a surface to be coated of the substrate to be coated.

2. A film coating; apparatus comprising:
a rotation retaining mechanism for horizontally retaining a substrate to be coaled and rotating the substrate to be coated,
wherein the rotation retaining mechanism has a table for directly or indirectly retaining the substrate to be coated and a gas supply means including a gas discharge hole fur supplying a gas to a rear surface of the substrate to be coated.

3. The film coating apparatus according to claim 2,
wherein the table has a chuck which contacts with and retains directly a portion of the rear surface of the substrate to be coated.

4. The film coating apparatus according to claim 3,
wherein the chuck is a vacuum chuck or an electrostatic chuck.

5-20. (canceled)

21. A film coating apparatus comprising:
a rotation retaining mechanism for retaining a substrate to be coated horizontally and rotating the substrate to be coated, the rotation retaining mechanism having a table for indirectly retaining the substrate to be coated and a gas discharge hole for supplying a gas into a space between the substrate to be coated and the table.
wherein the gas supplied from the gas discharge hole is exhausted from an outer circumference of the substrate to be coated at a flow speed greater than that of the gas which flows at other portions except for the outer circumference.

22. The film com ting apparatus of claim 2,
wherein a diameter at an ejection passage of the gas discharge hole is smaller than that at an upstream passage, to which the gas is supplied, of the gas discharge hole.

23. The film coating apparatus of claim 21,
wherein a diameter at an ejection passage of the gas discharge hole is smaller than that at an upstream passage, to which the gas is supplied, of the gas discharge hole.

24. A film coating apparatus comprising:
a rotation retaining mechanism for horizontally retaining a substrate to be coaled and rotating the substrate to be coated,
wherein the rotation retaining mechanism has a table for directly or indirectly retaining the substrate to be coated and a gas supply means including a gas discharge hole for supplying a gas to a rear surface of the substrate to be coated,
wherein the table has a Bernoulli chuck which retains at least, a portion of the rear surface of the substrate to be coated without contacting with, the rear surface of the substrate to be coated, and
wherein the table includes a plurality of clamp pins for clamping an outer circumference portion of the substrate to be coated.

25. The film coating apparatus of claim 21,
wherein the table includes a plurality of clamp pins for clamping an outer circumference portion of the substrate to be coated.

26. The film coating apparatus according to claim 24,
wherein an upper surface of the clamp pin is positioned at the same height as the surface to be coated of the substrate to be coated, or the upper surface of the clamp pin is positioned at a higher place than the surface to be coated of the substrate to be coated when the table retains and rotates the substrate to be coated.

27. The film coating apparatus of claim 2,
wherein a distance between the table and an outer circumference portion of the rear surface of the substrate to be coated is narrower than that between the table and the other portions so that the table can retain the outer circumference portion of the substrate by Bernoulli's effects.

28. The film coating apparatus of claim 21,
wherein a distance between the cable and an outer circumference portion of the rear surface of the substrate to be coated is narrower than that between the table and the other portions so that, the table can retain the outer circumference portion of the substrate by Bernoulli's effects.

29. A film coating apparatus comprising:
a rotation retaining mechanism for horizontally rotating a substrate to be coated and directly retaining a rear surface of the substrate to be coated; and
an indirect retaining mechanism for indirectly retaining an outer circumference portion of the substrate to be coated by Bernoulli's effects.
wherein the indirect retaining mechanism has a table placed at the rear surface of the substrate, a distance between the table and the outer circumference portion of the rear surface of the substrate to be coated is narrower than that between the table and the other portions, the indirect retaining mechanism having a gas discharge hole for supplying a gas to space between the rear surface of the substrate and the table, and the gas supplied from the gas discharge, hole is exhausted from an outer circumference of the substrate to be coated at a flow speed greater than that of the gas which flows at other portions except for the outer circumference.

30. The film coating apparatus of claim 1,
wherein the coating liquid is supplied by a coating liquid supplying system, the coating liquid supplying system, having a deacrator positioned at an upstream position of a pump, which is for supplying the coating liquid to remove a gas contained in the coating liquid.

31. The film coating apparatus of claim 2,
wherein the coating liquid is supplied by a coating liquid supplying system, the coating liquid supplying system having a deaerator positioned at an upstream position of a pump, which is for supplying the coating liquid, to remove a gas contained in the coating liquid.

32. The film coating apparatus of claim 21,
wherein the coating liquid is supplied by a coating liquid supplying system, the coating liquid supplying system having a deaerator positioned at an upstream position of a pump, which is for supplying the coating liquid, to remove a gas contained in the coaling liquid.

33. A film coating apparatus comprising:
a rotation retaining mechanism for horizon tally rotating a substrate to be coated and directly retaining a rear surface of the substrate to he coated; and
an indirect retaining mechanism for indirectly retaining an outer circumference portion of the substrate to be coated by Bernoulli's effects,
wherein the coating liquid is supplied by a coating liquid supplying system, the coating liquid supplying system having a deaerator positioned at an upstream position of a pump, which is for supplying the coating liquid, to remove a gas contained in the coating liquid.

34. The film coating apparatus of claim 1, further comprising:
a transfer mechanism for moving the substrate to be coated into an upper portion of the table and moving the substrate to be coated from the upper portion, the transfer mechanism being positioned through a blocking mechanism which is capable of blocking an atmosphere in the transfer mechanism from a film coating portion including the upper portion of the table; and
a gas supply means and a gas exhaust means for controlling the atmosphere in the transfer mechanism.

35. The film coating apparatus according of claim 2, further comprising:
a transfer mechanism for moving the substrate to be coated to an upper portion of the table and moving the substrate to be coated from the upper portion, the transfer mechanism being positioned through a blocking mechanism which is capable of blocking an atmosphere in the transfer mechanism from a film coating portion including the upper portion of the table; and
a gas supply means and a gas exhaust means for controlling the atmosphere in the transfer mechanism.

36. The film coating apparatus according of claim 21, further comprising:
a transfer mechanism for moving the substrate to be coated to an upper portion of the table and moving the substrate to be coated from the upper portion, the transfer mechanism being positioned through a blocking mechanism which is capable of blocking an atmosphere in the transfer mechanism from a film coating portion including the upper portion of the table; and
a gas supply means and a gas exhaust means for controlling the atmosphere in the transfer mechanism.

37. A film coating apparatus comprising:
a rotation retaining mechanism for horizontally rotating a substrate to be coated and directly retaining a rear surface of the substrate to be coated; and an indirect retaining mechanism for indirectly retaining an outer circumference portion of the substrate to be coated by Bernoulli's effects;
a transfer mechanism for moving the substrate to be coated to an upper portion of the table and moving the substrate to be coated from the upper portion, the transfer mechanism being positioned through a blocking mechanism which is capable of blocking an atmosphere in the transfer mechanism from a film coating portion including the upper portion of the table; and
a gas supply means and a gas exhaust means for controlling the atmosphere in the transfer mechanism.
